(19) United States
(12) Patent Application Publication
(10) Pub. No.: US 2008/0076415 A1
(43) Pub. Date: Mar. 27, 2008

(54) APPARATUS AND METHOD FOR CONTROLLING PILOT CHANNEL SEARCH IN A COMMUNICATION SYSTEM

(75) Inventors: Dong-Jun Kang, Hwaseong-si (KR); Woo-Sang Hong, Yongin-si (KR); Sang-Min Bae, Suwon-si (KR); Jin-Woo Heo, Seongnam-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/862,730

(22) Filed: Sep. 27, 2007

(30) Foreign Application Priority Data
Sep. 27, 2006 (KR) 2006-94192

(51) Int. Cl. H04Q 7/20

(52) U.S. Cl. 455/434

(57) ABSTRACT

A method for controlling pilot channel search by a terminal that receives a pilot channel signal from a base station in a mobile communication system. The method includes searching for a pilot of a service channel to determine received signal strength, determining whether there is a pilot list including an other channel in a neighbor list of the service channel, and if there is, determining whether to search for a pilot of the other channel according to the received signal strength of the pilot of the service channel.

### PRIORITY

This application claims priority under 35 U.S.C. § 119(a) to a Korean Patent Application filed in the Korean Intellectual Property Office on Sep. 27, 2006 and assigned Serial No. 2006-94192, the contents of which are incorporated herein by reference.

### BACKGROUND OF THE INVENTION

1. Field of the Invention

The present invention relates generally to a communication system, and in particular, to an apparatus and method for controlling pilot channel search in a communication system.

2. Description of the Related Art

Generally, the communication system has evolved from providing predominantly voice services into now providing data services. To meet the increasing demand for the data services, systems for high-speed data services have been developed, resulting in the advent of the Evolution-Data Optimized (EVDO) system for providing only the high-speed data services, and the Evolution Data and Voice (EVDV) system capable of providing both voice services and high-speed data services.

In the EVDO system, the term ‘pilot set’ as used herein refers to a set of base stations satisfying a condition. The pilot set is classified into such sets as an active, a candidate, a neighbor and a remaining set.

The active set indicates a pilot Pseudo Noise (PN) set to which a forward channel is assigned. The candidate set indicates a pilot PN set having sufficient electric field strength, though it is not the active set. The neighbor set is a pilot PN set that can fully be a candidate set, for handoff. The remaining set indicates a pilot PN set received from a terminal, other than the above sets. The terminal manages the limited number of active, candidate, neighbor and remaining sets. This is to clearly define the classification of the pilot sets, and handle the processing between them.

The terminal continuously searches for the active, candidate, neighbor and remaining sets in an idle and a connected state to keep the optimal channel environment. When there is a need for movement between the pilot sets, the terminal can move between the sets taking the handoff into account.

In some cases, for the active, the candidate and the remaining sets, the terminal should search for pilots in a service channel, whereas for the neighbor set, the terminal should search for pilots not only in the service channel but also in an ‘other channel’. Herein, the term ‘other channel’ refers to a channel that is different in frequency from the current service channel. A base station transmits a neighbor list over a Sector Parameter message in the idle state and over a Neighbor List message in the connected state, and transmits pilot information and channel information of the neighbor list together. Here, not only the pilot of the neighbor list included in the service channel, but also the pilot of the neighbor list included in other channel can exist. In this case, the terminal should also search for the pilot belonging to the other channel.

FIG. 1 illustrates a method for controlling channel search in the conventional communication system.

In step 101, a terminal starts channel search control, and then determines in step 103 whether there is any neighbor pilot of other channel.

If there is any neighbor pilot of other channel, the terminal proceeds to step 105 where it determines whether a timer for pilot search of other channel has expired.

If the timer has expired, the terminal proceeds to step 107 where it performs Radio Frequency (RF) tuning to a corresponding channel and then searches for a neighbor pilot of other channel. However, if the timer has not expired, the terminal proceeds to step 111 described below.

However, if there is no neighbor pilot of other channel in step 103, the terminal performs a search according to a general search algorithm in step 109. The general search process is performed as follows.

First, in step 111, the terminal configures an active set and a candidate set. Thereafter, the terminal determines in step 113 whether there is any remaining storage space for the search.

If there is no remaining space for the search, the terminal returns to step 101 where it re-starts the channel search control.

However, if there is any remaining space for the search, the terminal configures in step 115 a neighbor set corresponding to the remaining space and performs a search thereon. In this case, the terminal determines in the service channel whether to perform handoff using a value negotiated in a SetManagementSameChannelParameters attribute, and determines in the other channel whether to perform handoff using a value negotiated in a SetManagementDifferentChannelParameters attribute. The field values corresponding to each of the attributes can be either equal or different according to base stations. Herein, the ‘field value’ is a parameter value transmitted from the base station to the terminal.

FIG. 2 illustrates a conventional search order between a service channel and other channel.

When there is a pilot including other channel in a neighbor list, the terminal basically searches for a pilot corresponding to the other channel if a timer for other channel search has expired while searching for pilots corresponding to the service channel (performing the search according to the general search algorithm) before the timer expires. That is, conventionally, in 210 and 220 where there is a pilot including other channel, the terminal periodically searches for the corresponding pilot through timer setting regardless of the surrounding environment.

Conventionally, in the service channel, the terminal performs a search on an active, a candidate and a neighbor set at an appropriate channel search rate. However, there is a problem in that the terminal does not perform the search until a time period has elapsed, i.e. the timer has expired, even though there is a neighbor pilot of the other channel in the neighbor list.

If pilot energy of the active set and candidate set is measured high in the service channel, no handoff-related problem may occur even though the method of periodically searching for a neighbor pilot of other channel using the timer is used. However, if the method of periodically searching for a pilot using the timer in the conventional manner is used when the pilot energy is measured low, a connection close problem may occur as the terminal misses the time to perform handoff to other channel in the idle or connected state. That is, the terminal may fail to determine handoff as it misses the search time of the other channel, causing disconnection of the current connection.

The method of periodically searching for a corresponding pilot through timer setting without additionally considering the surrounding environment may have the following problems.

First, to perform RF tuning from the service channel to the other channel, or to perform the opposite RF tuning, there is a need for a stabilization time related to RF hardware, and if an EVDO terminal was receiving data in the connected state for this time, it checks Cyclic Redundancy Check (CRC), so CRC bad may occur or may be held for a time period.

Second, a terminal capable of a hybrid mode supporting both 1× and EVDO should periodically perform monitoring of other channel if not only 1× interface switching but also a condition are satisfied, while the EVDO terminal receives data in the connected state. To perform each monitoring, there is a need for RF tuning and a hardware stabilization time.

### SUMMARY OF THE INVENTION

An aspect of the present invention is to address at least the problems and/or disadvantages and to provide at least the advantages described below. Accordingly, an aspect of the present invention is to provide an apparatus and method for controlling pilot channel search to keep an optimal channel environment in a terminal.

An aspect of the present invention is to provide a pilot channel search control apparatus and method for performing channel search according to the current channel condition when there is other channel in a neighbor list.

An aspect of the present invention is to provide a pilot channel search control apparatus and method for using an adaptive method according to the surrounding channel environment, thereby reducing the problem that CRC bad occurs or is held for a time period while receiving data.

An aspect of the present invention is to provide a pilot channel search control apparatus and method for solving the problem that a terminal fails to determine handoff as it misses a search time of other channel, causing disconnection of the current connection.

An aspect of the present invention is to provide a pilot channel search control apparatus and method for solving the problem that a terminal capable of a hybrid mode supporting both 1× and EVDO should periodically perform monitoring of other channel if not only 1× interface switching but also a condition are satisfied while an EVDO terminal receives data in a connected state, and that to perform each monitoring, there is a need for RF tuning and a hardware stabilization time.

According to the present invention, there is provided a method for controlling pilot channel search by a terminal that receives a pilot channel signal from a base station in a mobile communication system. The pilot channel search control method includes searching for a pilot of a service channel to determine received signal strength, determining whether there is a pilot list including other channel in a neighbor list of the service channel, and if there is a pilot list including other channel in the neighbor list, determining whether to search for a pilot of other channel according to the received signal strength of the pilot of the service channel.

According to the present invention, there is provided an apparatus for controlling pilot channel search of a terminal that receives a pilot channel signal from a base station in a mobile communication system. The pilot channel search control apparatus includes a receiver for receiving a pilot channel signal from the base station via an antenna, an energy calculator for calculating energy values of the received signals, and outputting received signal strengths of pilots; a reorderer for reordering the received signal strengths of the pilots for pilot sets, a controller for determining whether there is a pilot list including other channel in a neighbor list of a service channel, and determining whether to search for a pilot of other channel according to received signal strength of the service channel if there is a pilot list including other channel in the neighbor list, and an RF converter for performing RE tuning to search for a pilot of a neighbor list of the other channel under control of the controller.

According to the present invention, there is provided an apparatus for controlling pilot channel search of a terminal that receives a pilot channel signal from a base station in an Orthogonal Frequency Division Multiplexing (OFDM) communication system. The pilot channel search control apparatus includes a receiver for receiving a transmitted signal from the base station; an energy calculator for calculating energy of a pilot channel signal among the received signals, and outputting received signal strength of a pilot, an OFDM modem for demodulating an OFDM symbol transmitted from the base station; a controller for determining whether there is a pilot list including other channel in a neighbor list of a service channel, and determining whether to search for a pilot of other channel according to received signal strength of the pilot of the service channel if there is a pilot list including other channel in the neighbor list, and an RF converter for performing RF tuning to search for a pilot of a neighbor list of the other channel under control of the controller.

### BRIEF DESCRIPTION OF THE DRAWINGS

The above and other aspects, features and advantages of the present invention will become more apparent from the following detailed description when taken in conjunction with the accompanying drawings in which:

FIG. 1 illustrates a method for controlling pilot channel search in the conventional communication system;

FIG. 2 illustrates a conventional search order between a service channel and other channel;

FIG. 3 illustrates a pilot channel search order in the good surrounding channel environment;

FIG. 4 illustrates a pilot channel search order in the normal surrounding channel environment;

FIG. 5 illustrates a pilot channel search order in the bad surrounding channel environment;

FIG. 6 illustrates a pilot channel search control method in a communication system according to an embodiment of the present invention;

FIG. 7 illustrates a block diagram of a pilot channel search control apparatus in a communication system according to an embodiment of the present invention; and

FIG. 8 illustrates a block diagram of a pilot channel search control apparatus in a communication system according to another embodiment of the present invention.

### DETAILED DESCRIPTION OF THE PREFERRED EMBODIMENTS

Preferred embodiments of the present invention will now be described in detail with reference to the annexed drawings. In the following description, a detailed description of known functions and configurations incorporated herein has been omitted for clarity and conciseness.

Conventionally, when there is a pilot including an other channel in a neighbor list, the terminal basically searches for a pilot channel corresponding to the other channel if a timer for the other channel search has expired while searching for pilots corresponding to the service channel before the timer expires.

However, the present invention provides an apparatus and method for adaptively searching for a pilot channel according to the surrounding channel environment to search another channel when there is a pilot including the other channel in the neighbor list.

It is assumed herein that a terminal recognizes the presence of a neighbor pilot including the other channel in a neighbor list as the time when it should perform handoff from the current service channel to the other channel.

When there is a pilot including the other channel in the neighbor list, the present invention is divided into the following three steps according to energy values of active set pilots, i.e. received signal strengths of active sets.

1. When energy values of the active set pilots are greater than −3 dB, the surrounding channel environment is assumed to be good.

2. When energy values of the active set pilots are greater than −7 dB and less than −3 dB, the surrounding channel environment is assumed to be normal.

3. When energy values of the active set pilots are less than −7 dB, the surrounding channel environment is assumed to be bad.

The reference ‘−3 dB’ in steps 1 and 2 indicates an energy level at about which a terminal transmits a high Data Rate Control (DRC) value and a base station transmits a packet at a high data rate. The reference ‘−7 dB’ in steps 2 and 3 indicates an energy level at about which a demotion from the active set can be made. These values, measured in the channel environment, are at a reliable level.

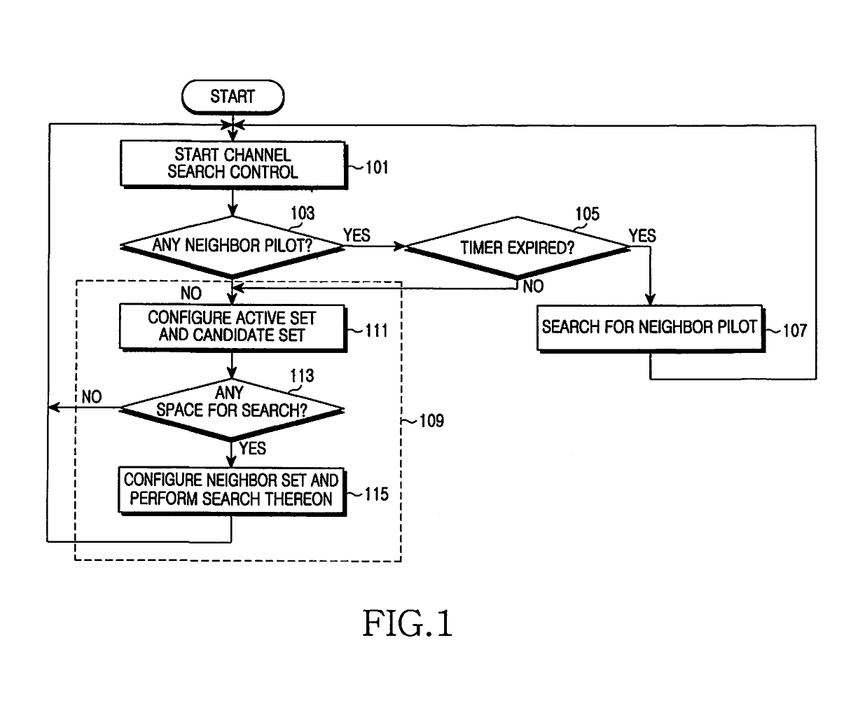

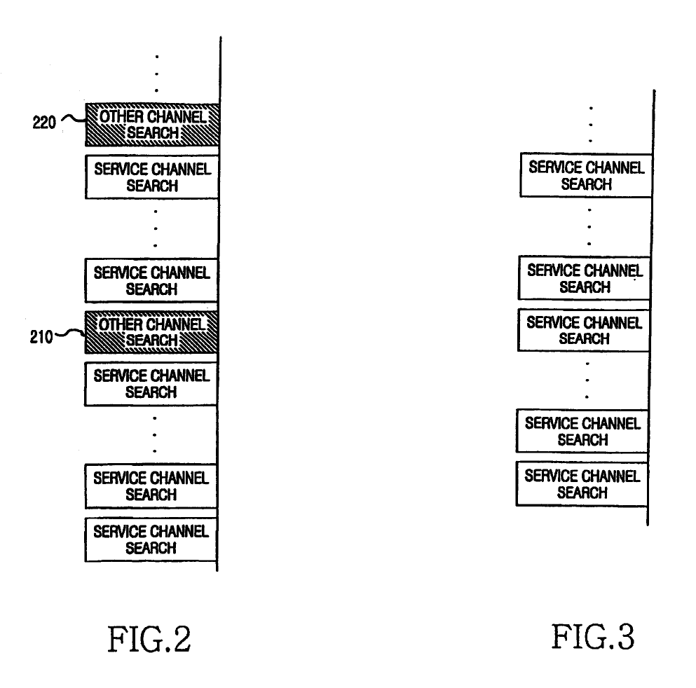

In step 1, when energy values of the active set pilots are greater than −3 dB, the terminal performs a search according to the general search algorithm as shown in FIG. 3 without searching for a pilot of other channel, determining that it is efficient to make no search rather than raising the problem that CRC bad occurs or is held for a time period while receiving data by performing RF tuning to search for a pilot of other channel. The general search algorithm corresponds to step 109 of FIG. 1. FIG. 3 illustrates a pilot search order when the surrounding channel environment is good.

Generally, when the surrounding channel environment is good, the terminal transmits a high DRC value and the base station also transmits a packet at a high data rate as requested by the terminal. In this situation, to raise the problem by performing RF tuning to search for a pilot of other channel results in loss other than gain. In this case, therefore, the terminal makes no search even though there is a pilot of other channel.

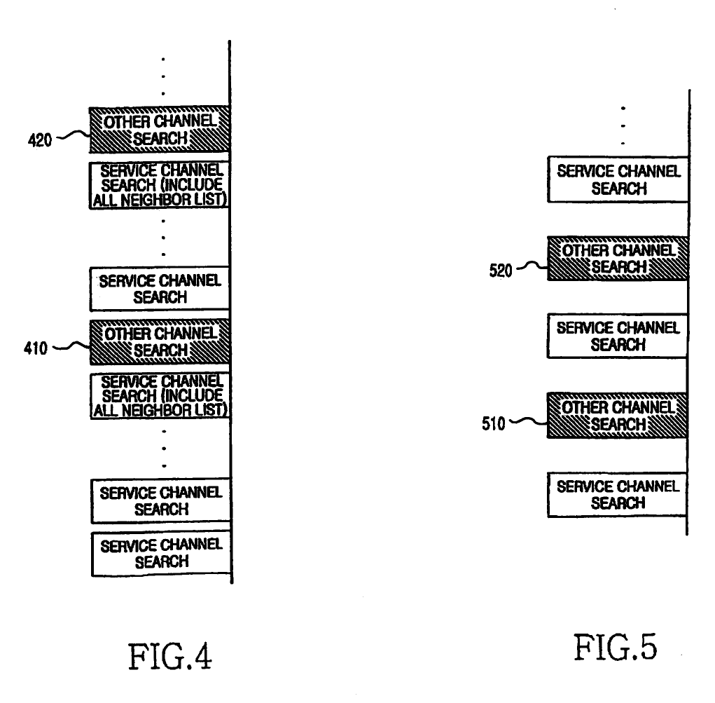

In step 2, when energy values of the active set pilots are greater than −7 dB and less than −3 dB, the terminal fully searches the neighbor list of the service channel according to the general search algorithm (step 109 of FIG. 1), and then searches once for a neighbor pilot 410 of the other channel as shown in FIG. 4, which reflects a pilot search order when the surrounding channel environment is normal.

FIG. 4 illustrates a process of searching for a pilot of other channel after searching at least once for all pilots of an active, a candidate and a neighbor set in the current service channel using the general search algorithm.

In the above step 3, when energy values of the active set pilots are less than −7 dB, the terminal makes one search according to the general search algorithm (step 109 of FIG. 1), and then searches for a neighbor pilot 510 of other channel as shown in FIG. 5, which reflects a pilot search order when the surrounding channel environment is bad.

FIG. 5 illustrates a method for performing handoff to other channel before a connection is disconnected by frequently searching for a pilot of other channel in the situation whether the surrounding channel environment is bad as a terminal periodically searches other channel once. The terminal makes a search as frequently as possible to find a high-power pilot in neighbor other channels 510 and 520 as it has failed to find a pilot having a high power level at around which the terminal can receive data in the current service channel.

Generally, when the surrounding channel environment is bad, the terminal transmits a low DRC value and the base station also transmits a packet at a low data rate as requested by the terminal. Therefore, it is efficient for the terminal to find a pilot having a power level necessary for handoff as rapidly as possible and perform sector switching by frequently searching for a pilot of other channel, even though raising the problem that a bad CRC occurs or is held for a time period for the data that it is receiving.

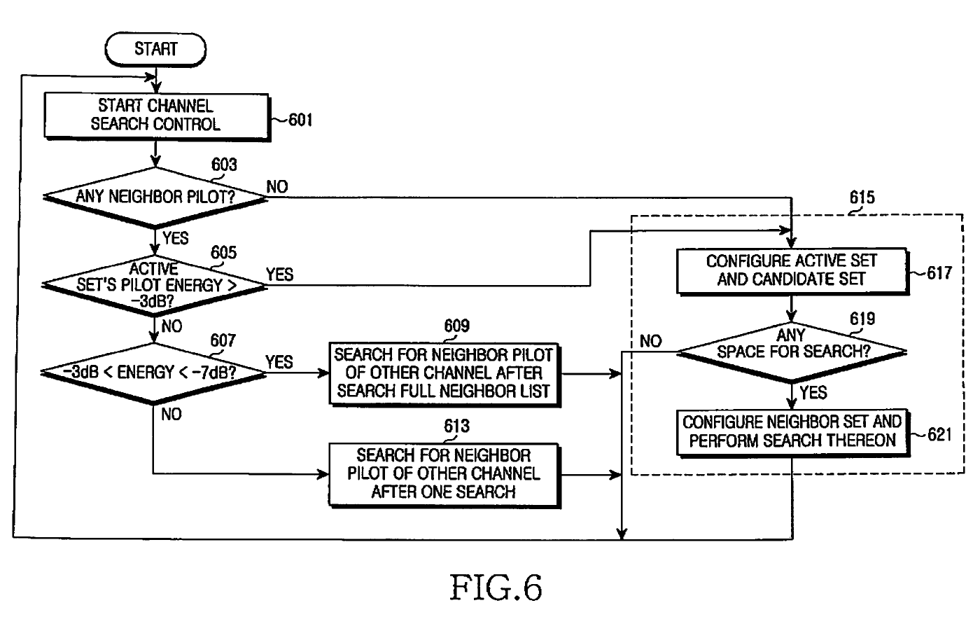

FIG. 6 illustrates a channel search control method in a communication system according to an embodiment of the present invention.

In step 601, a terminal starts channel search control, and then determines in step 603 whether there is any neighbor pilot of the other channel.

If there is no neighbor pilot of the other channel, the terminal proceeds to step 615 where it performs channel search according to the general channel search algorithm. The general channel search process is equal to that described in step 109 of FIG. 1, so a description thereof will be omitted herein for the sake of conciseness.

However, if there is any neighbor pilot of other channel, the terminal measures in step 605 energy values of active set pilots to determine whether the energy values of the active set pilots are greater than −3 dB. If the energy values of the active set pilots are greater than −3 dB, the terminal proceeds to step 615 where it performs channel search according to the general channel search algorithm without searching for a pilot of the other channel because it is efficient to make no search rather than raising the problem that a bad CRC occurs or is held for a time period while receiving data by performing RF tuning to search for a pilot of the other channel.

If, however, the energy values of the active set pilots are less than or equal to −3 dB, the terminal determines in step 607 whether the energy values of the active set pilots are greater than −7 dB and less than −3 dB. If the energy values of the active set pilots are greater than −7 dB and less than −3 dB, the terminal proceeds to step 609 where it fully searches a neighbor list of the service channel according to the general search algorithm (step 109 of FIG. 1), and then searches once for a neighbor pilot 410 of the other channel as shown in FIG. 4. After step 609, the terminal re-starts the channel search control in step 601.

However, if it is determined in step 607 that the condition is not satisfied, the terminal proceeds to step 613 where it searches once the neighbor list of the service channel according to the general search algorithm (step 109 of FIG. 1), and then searches for a neighbor pilot 510 of the other channel as shown in FIG. 5. After step 613, the terminal returns to step 601 where it re-starts the channel search control.

A description will now be made of a pilot channel search apparatus to which the foregoing pilot channel search control method is applied.

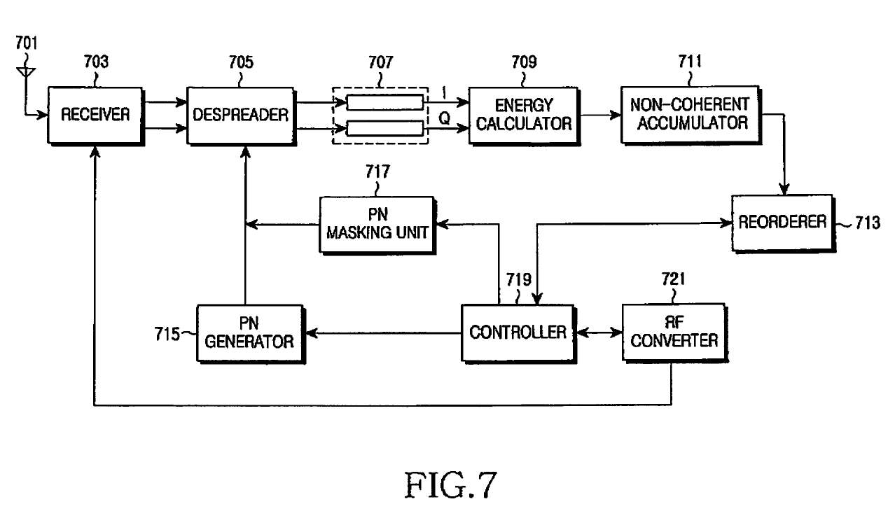

FIG. 7 illustrates a block diagram of a channel search control apparatus in a communication system according to an embodiment of the present invention. Particularly, shown in FIG. 7 is a block diagram of the other channel search control apparatus in the CDMA system.

A pilot channel signal of a base station, received via an antenna 701 and a receiver 703, is input to a despreader 705 after being separated into an In-Phase (I) component and a Quadrature (Q) component.

A PN generator 715 and a PN masking unit 717 generate PN codes corresponding to a pilot set under the control of a controller 719, and the despreader 705 despreads the I and Q signal components using the input PN codes. The despread signals are input to a coherent accumulator 707. The coherent accumulator 707 sequentially accumulates the despread signals, and the accumulated despread signals are input to an energy calculator 709. The energy calculator 709 calculates energy of the pilot channel signal by squaring and adding up the accumulated I and Q signal components, and the calculated energy is input to a non-coherent accumulator 711. The non-coherent accumulator 711 accumulates the calculated energy value for a time period to calculate an average value thereof, and the calculated average value is input to a reorderer 713. The reorderer 713 reorders the average energy values calculated for the pilot sets.

The controller 719 reads the reordered average energy values from the reorderer 713, and performs such operation as pilot channel acquisition, finger assignment and set maintenance according to a set routine. Further, the controller 719 controls a general pilot searcher included in a terminal to search for a pilot of a service channel, and then determines whether to perform a channel search according to the surrounding environment if there is any pilot including the other channel in a neighbor list.

The controller 719 controls an RF converter 721 by means of an undepicted transmission module, and if the energy values of the active set pilots are less than a set level, the controller 719 searches for a pilot of a neighbor list by performing RF tuning to search the other channel. The RF converter 721, under the control of the controller 719, performs RF tuning to search for a pilot of the other channel in the neighbor list.

Although the foregoing technique has been described herein with reference to the EVDO system, by way of example, the same can be applied even to an OFDM-based Long Term Evolution (LTE) system.

Even in the OFDM system, not only the pilot information of the service channel but also the pilot information of the other channel exists in the neighbor list. For inter-channel handoff, the terminal should search for pilots of other channel and monitor energy values of the pilots. The algorithm disclosed in the present invention, which is roughly divided to three steps according to energy values of the active set pilots to control a search of the other channel, can be applied even to the OFDM system. If it is determined, based on pilot information of each sub-channel in the currently assigned service channel, that energy values of the active set pilots are less than a set level, the terminal changes the center frequency and determines whether to perform handoff depending on the pilot energy value of each sub-channel in the other channel. A detailed description thereof will be omitted herein for the sake of conciseness.

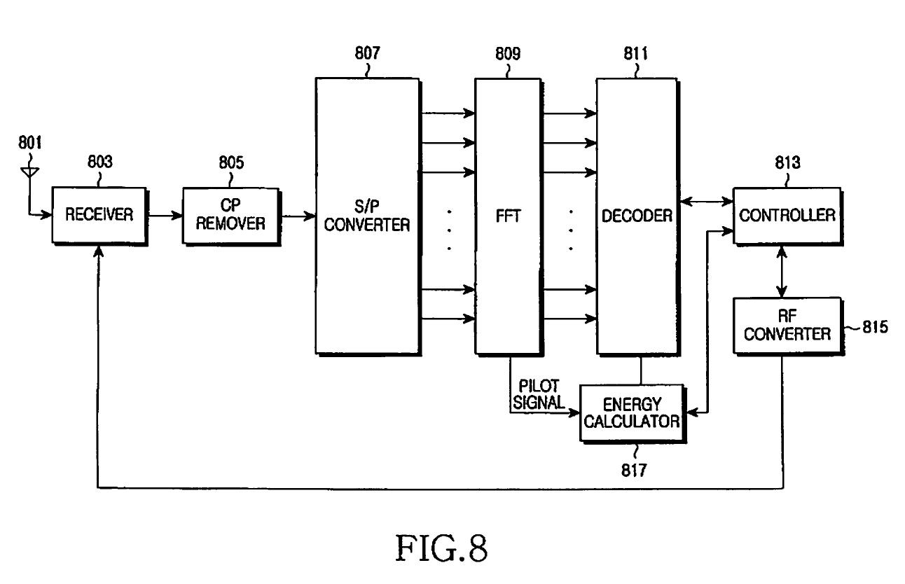

FIG. 8 illustrates a block diagram of a channel search control apparatus in a communication system according to another embodiment of the present invention. Particularly, shown in FIG. 8 is a terminal's receiver structure for receiving information from a base station in the OFDM system.

A received signal including the data and control information received from the base station via an antenna 801 and a receiver 803 is delivered to a Cyclic Prefix (CP) remover 805. The CP remover 805 removes a CP from the received signal, and the CP-removed signal is input to a Serial-to-Parallel (S/P) converter 807. The S/P converter 807 converts the CP-removed serial signal into a parallel signal, and the parallel-converted signal is input to a Fast Fourier Transform (FFT) unit 809. The FFT unit 809 performs FFT on the parallel-converted signal, and the FFT-processed signal is input to a decoder 811 and an energy calculator 817.

The energy calculator 817 calculates energy of a pilot signal using only the pilot signal among the output signals of the FFT unit 809. A controller 813 reads reordered average energy values of the pilot signals, performs a corresponding operation according to a set routine. In addition, the controller 813 searches for a pilot of the service channel, and then determines whether to perform a search if there is a pilot including other channel in the neighbor list.

The controller 813 controls an RF converter 815 by means of an undepicted transmission module, and if the energy values of the active set pilots are less than a set level, the controller 813 searches for a pilot of a neighbor list by performing RF tuning to search other channel. The RF converter 815, under the control of the controller 813, performs RF tuning to search for a pilot of other channel in the neighbor list.

It can be noted from FIGS. 7 and 8 that the present invention can be applied to both the EVDO system and the OFDM system.

As is apparent from the foregoing description, the present invention can be applied to when there is a pilot including other channel in the neighbor list, and can efficiently solve the problem that a bad CRC occurs or is held for a time period if the EVDO terminal or the OFDM terminal is receiving data in the situation where it should perform RF tuning.

The present invention can efficiently solve the problem that a terminal capable of a hybrid mode supporting both 1× and EVDO should periodically perform monitoring of other channel if not only 1× interface switching but also a condition are satisfied while the EVDO terminal receives data.

The present invention, roughly divided into three steps according to the current channel condition, performs a channel search using an adaptive method, thereby maintaining an optimal channel environment.

Although it can be seen by the present invention that the number of searches for a pilot of the other channel is lower than that of the prior art, the present invention uses a method of making the search more frequently in the bad channel environment, thereby increasing the number of channel searches compared with the prior art.

The present invention solves the problem that the terminal fails to determine handoff as it misses the search time of the other channel, thus causing disconnection of the current connection.

The present invention solves the problem that a terminal capable of a hybrid mode supporting both 1× and EVDO should periodically perform monitoring of other channel if not only 1× interface switching but also a condition are satisfied while an EVDO terminal receives data in a connected state, and that to perform each monitoring, there is a need for RF tuning and a hardware stabilization time.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for controlling pilot channel search by a terminal that receives a pilot channel signal from a base station in a mobile communication system, the method comprising:
searching for a pilot of a service channel to determine received signal strength;
determining whether there is a pilot list including an other channel in a neighbor list of the service channel; and
determining, if there is a pilot list including the other channel in the neighbor list, whether to search for a pilot of the other channel according to the received signal strength of the pilot of the service channel.

2. The method of claim 1, further comprising:
searching, if the received signal strength of the pilot of the service channel is less than a first threshold, for a neighbor pilot of the other channel included in the neighbor list at a first frequency.

3. The method of claim 2, wherein the first threshold includes an energy level at about which a demotion from an active set can be made.

4. The method of claim 2, further comprising:
searching, if the received signal strength of the pilot of the service channel is greater than the first threshold and less than a second threshold, for a neighbor pilot of the other channel included in the neighbor list at a second frequency being less than the first frequency.

5. The method of claim 4, wherein the second threshold includes an energy level at about which the terminal transmits a high Data Rate Control (DRC) value and the base station transmits a packet at a high data rate.

6. The method of claim 1, further comprising:
searching, if the received signal strength of the pilot of the service channel is greater than a second threshold, for a pilot of the service channel without searching for a pilot of the other channel.

7. The method of claim 1, wherein the other channel includes a channel that is different in frequency from the service channel.

8. An apparatus for controlling pilot channel search of a terminal that receives a pilot channel signal from a base station in a mobile communication system, the apparatus comprising:
a receiver for receiving a pilot channel signal from the base station via an antenna;
an energy calculator for calculating energy values of the received signals, and outputting received signal strengths of pilots;
a reorderer for reordering the received signal strengths of the pilots for pilot sets;
a controller for determining whether there is a pilot list including an other channel in a neighbor list of a service channel, and determining whether to search for a pilot of the other channel according to received signal strength of the service channel if there is a pilot list including the other channel in the neighbor list; and
a Radio Frequency (RF) converter for performing RF tuning to search for a pilot of a neighbor list of the other channel under control of the controller.

9. The apparatus of claim 8, wherein if the received signal strength of the pilot of the service channel is less than a first threshold, the controller searches for a neighbor pilot of the other channel included in the neighbor list at a first frequency.

10. The apparatus of claim 9, wherein the first threshold includes an energy level at about which a demotion from an active set can be made.

11. The apparatus of claim 9, wherein if the received signal strength of the pilot is greater than the first threshold and less than a second threshold, the controller searches for a neighbor pilot of the other channel included in the neighbor list at a second frequency being less than the first frequency.

12. The apparatus of claim 11, wherein the second threshold includes an energy level at about which the terminal transmits a high Data Rate Control (DRC) value and the base station transmits a packet at a high data rate.

13. The apparatus of claim 8, wherein if the received signal strength of the pilot is greater than a second threshold, the controller searches for a pilot of the service channel without searching for a pilot of the other channel.

14. The apparatus of claim 8, wherein the other channel includes a channel that is different in frequency from the service channel.

15. An apparatus for controlling pilot channel search of a terminal that receives a pilot channel signal from a base station in an Orthogonal Frequency Division Multiplexing (OFDM) communication system, the apparatus comprising:
a receiver for receiving a transmitted signal from the base station;
an energy calculator for calculating energy of a pilot channel signal among the received signals, and outputting received signal strength of a pilot;
an OFDM modem for demodulating an OFDM symbol transmitted from the base station;
a controller for determining whether there is a pilot list including an other channel in a neighbor list of a service channel, and determining whether to search for a pilot of the other channel according to received signal strength of the pilot of the service channel if there is a pilot list including the other channel in the neighbor list; and
a Radio Frequency (RF) converter for performing RF tuning to search for a pilot of a neighbor list of the other channel under control of the controller.

16. The apparatus of claim 15, wherein if the received signal strength of the pilot is less than a first threshold, the controller searches for a neighbor pilot of the other channel included in the neighbor list at a first frequency.

17. The apparatus of claim 16, wherein the first threshold includes an energy level at about which a demotion from an active set can be made.

18. The apparatus of claim 16, wherein if the received signal strength of the pilot is greater than the first threshold and less than a second threshold, the controller searches for a neighbor pilot of the other channel included in the neighbor list at a second frequency being less than the first frequency.

19. The apparatus of claim 18, wherein the second threshold includes an energy level at about which the terminal transmits a high Data Rate Control (DRC) value and the base station transmits a packet at a high data rate.

20. The apparatus of claim 15, wherein if the received signal strength of the pilot is greater than a second threshold, the controller searches for a pilot of the service channel without searching for a pilot of the other channel.

21. The apparatus of claim 15, wherein the other channel includes channel that is different in frequency from the service channel.
